(19) United States
(12) Patent Application Publication
(10) Pub. No.: US 2008/0246401 A1
(43) Pub. Date: Oct. 9, 2008

(54) Electric lamp with a laser-structured metal fuse seal

(75) Inventors: Axel Bunk, Munich (DE); Christa Bunk, Munich (DE); Heinz Lang, Schernfeld (DE); Georg Rosenbauer, Wassertrudingen (DE); Matthias Damm, Gaimersheim (DE)

Correspondence Address: COHEN PONTANI LIEBERMAN & PAVANE LLP, Suite 1210, 551 Fifth Avenue, New York, NY, 10176, US

(73) Assignee: OSRAM Gesellschaft mit beschrankter Haftung, Munchen (DE)

(21) Appl. No.: 12/079,608

(22) Filed: Mar. 27, 2008

(30) Foreign Application Priority Data
Mar. 29, 2007 (DE) 10 2007 015 243.6
Jun. 29, 2007 (DE) 20 2007 009 119.2

(51) Int. Cl. H01J 17/18; H01J 9/02

(52) U.S. Cl. 313/623; 445/27

(57) ABSTRACT

An electric lamp with a fuse seal, which seals off the lamp bulb, a metal seal with power supply wires and feed lines being provided in the fuse seal, and the metal seal with power supply wires and feed lines being provided with a structure, which has been produced by a laser.

### FIELD OF THE INVENTION

The invention relates to an electric lamp, in particular to an electric incandescent or discharge lamp, comprising at least one hermetically sealed lamp bulb, at least one luminous element or electrode arranged in the interior of the lamp bulb and a power supply system for the luminous element or the electrode. The power supply system is passed out of the lamp bulb through a pinch seal, which hermetically seals off the lamp bulb, and is provided with a metal seal in the region of the pinch seal.

### BACKGROUND OF THE INVENTION

Precisely in the case of electric lamps with a vessel consisting of quartz glass it is very difficult, owing to the different coefficients of expansion of quartz glass (0.5×10⁻⁶ 1/K) and molybdenum (5.6×10⁻⁶ 1/K), to safely close the pinch seal when the power supply wires are passed through. For this reason, the power supply wire is interrupted in the region of the pinch seal and the interspace is replaced by an extremely thin metal seal (<40 μm in thickness). That part of the power supply wire which is passed to the outside is referred to as the feed line. This feed line can be manufactured from a different material than the power supply wire. The power supply wire consists, for example, of doped molybdenum or of tungsten, as is the case for the electrode in discharge lamps. Molybdenum and tungsten are very high-quality materials and therefore are comparatively very expensive. Such a high-quality material is not absolutely necessary for the feed lines.

The metal seal preferably consists of a molybdenum foil. During lamp operation, fissures in the glass result from the reaction of the material of the metal seal with oxygen or with the filling constituents of the lamp in the region of the seal as a result of an increase in volume of the sealing material (for example molybdenum oxide has a lower density than molybdenum), and these fissures in the glass may result in the lamp not being sealtight. Roughening the surface of the foil improves the glass sealing with the quartz glass, which results in a more permanent glass/metal composite. As a result of this improved glass sealing, the development of fissures in the glass is delayed, which is associated with an extended lamp life.

According to the prior art, roughening takes place, for example, by means of etching processes. In this case, the foil is laid into an acid bath or alkaline bath or treated in a targeted manner by means of electrochemical abrasion.

Likewise known is a mechanical treatment of the foil. The surface is provided, for example, with punched holes, through which the material of the lamp bulb can pass in the region of the pinch seal. A surface roughness can also be provided by means of mechanical processing (for example sandblasting). It is likewise known to coat the surface with an adhesive layer (titanium oxide particles) or to dope the material with oxide particles (for example yttrium oxide).

All of the previously known treatment methods for configuring the metal seal in such a way that the pinch seal can be sealed off in a more reliable manner are very complex and expensive.

### SUMMARY OF THE INVENTION

One object of the invention is to provide an electric lamp as described above, in which the entire metal fuse seal, i.e. the metal seal, the power supply wires and the feed lines, are processed in an inexpensive manner in order to reliably seal off the lamp bulb.

This and other objects are attained in accordance with one aspect of the present invention directed to an electric lamp comprising a hermetically sealed lamp bulb, at least one luminous means arranged in the interior of the lamp bulb, and a power supply system for the luminous means. The power supply system is passed out of the lamp bulb through a pinch seal, which hermetically seals off the lamp bulb, and the power supply system having a laser-processed metal foil seal in the region of the pinch seal.

Processing by means of a laser has the advantage over the known processing methods of it being contactless processing. With the known processing methods there is the risk in the case of the mechanical processing that the fuse-in foil, which is very thin, becomes deformed or even damaged. During the etching process or during coating, there is the disadvantage that only a large-area surface of the fuse-in metal or of the wire can be processed, while in the laser process local points in the case of the metal fuse seal within the glass pinch seal can be processed in a targeted manner.

It is also possible with a laser to produce subsurface engraving. By means of focusing the laser beam, for example via a mirror scanner or an optical lens, onto the same point, a change in the material can be brought about below the surface of a material, which change is visible in the case of a transparent or translucent material.

It is also possible with a laser to produce subsurface engraving. By means of focusing the laser beam, for example via a mirror scanner or an optical lens, onto the same point, a change in the material can be brought about below the surface of a material, which change is visible in the case of a transparent or translucent material. After the laser processing, it is therefore possible to process a material which is arranged in another material without the second material, which surrounds or covers the first material, being changed. It is in principle possible with the laser processing, when using a suitable wavelength for the laser radiation (for example Nd-YAG lasers with a wavelength of 1.06 μm), to still process the metal seal, the electrodes and the power supply lines even when they have already been embedded in the pinch seal of the lamp bulb.

In an embodiment of the invention, the metal seal or the electrode of the discharge lamp or the power supply line and the feed line is/are provided with a structure. The surface of the metal seal is not only roughened, but has a structure with a specific geometry. Any desired geometries can in this case be set by scanning of the laser beam on the metal foil. Alternatively, the metal foil can also be moved relative to the fixed laser beam. In the case of wire sections, the surface structure can also extend over the entire circumference by the wire being rotated about its own axis during laser processing.

In general, the contour of the processed point runs in tapered fashion, i.e. the further the beam enters into the material, the greater the diameter of the processed point in the region of the surface and the more it tapers in the direction towards the center of the material. The incorporated depression is, for example, in the form of a V. In the case of perforations, the edges should run out gently similarly to the lanceolated outer edges of the metal foil since otherwise the composite stresses in the glass/metal composite become too great and the glass cracks open and cracks result.

However, it is also possible to align the laser beam in such a way that side walls aligned parallel to one another result at the processed point. Depending on the selection of the pulse frequency of the laser, melt sputtering can be avoided and complete sublimation of the material can take place. In this case, relatively precise depression geometries and cutting edges can be formed in the μm range.

In the case of perforations with side walls which are aligned parallel to one another, fissures in the glass preferably result after pinch-sealing since the glass-metal composite stresses are extremely great at the sharp-edged shoulders. These local fissures in the glass (for example local circular fissure around a punctiform bullet-like hole) can also be provided in a targeted manner as local strain-relief fissures in the pinch seal. Local strain-relief fissures can therefore be incorporated, for example, at critical points and the stress in the glass/metal composite can be reduced. Another aim of the strain-relief fissures is the guidance of the cracks in the glass into uncritical regions. In the case of some lamps, fissures in the glass around the power supply lines or the feed lines cannot be avoided after fuse-sealing. As a result of the targeted placement of sharp-edged laser depressions or laser bullet-like holes on the metal seal or the power supply lines and feed lines, the fissures in the glass can be guided in such a way that a continuous crack to the outer atmosphere of the pinch seal (lack of sealtightness of the lamp) can be prevented. The crack is guided in such a way that it remains within the pinch seal and there is no contact with the outer atmosphere.

As a preferred example, a discharge lamp as is used, for example, in video projection systems, in automobile front headlamps or display window lights, can be mentioned.

In this case, the laser structure on the electrode should guide the fissures in the adhesive in such a way that the crack moves in a targeted manner from one laser structure to the next laser structure and does not move to the outside of the discharge vessel. Preferably, two sharp-edged circumferential grooves are incorporated into the electrode by means of a laser. The fissures in the adhesive which sometimes occur in any case can therefore be guided back in a targeted manner within the discharge vessel.

In accordance with a first exemplary embodiment, the structure is in the form of a depression, which has been incorporated into the material of the metal seal. In accordance with one variant, this depression is punctiform. In the simplest case, only one punctiform depression is provided in the metal seal. Advantageously, however, the punctiform depressions are distributed over the entire surface of the metal seal, possibly distributed arbitrarily or arranged locally around the weld points. In accordance with a further variant, the punctiform depressions are arranged in accordance with a pattern, it in turn being possible for the pattern to be selected arbitrarily. The punctiform depressions can be arranged, for example, on lines or curves which are arranged parallel to one another, on concentric circles or rectangles, in spiral fashion or in accordance with another pattern.

According to a further variant of the invention, the depressions are provided in the form of continuous lines. These lines extend, for example, parallel to the upper or lower edge of the metal seal. They can also be aligned parallel to the lateral edges of the metal seal. In accordance with a further variant, these lines are distributed diagonally or substantially diagonally on the surface of the metal seal. In accordance with a further variant, these lines intersect one another. These lines form a net, for example. The lines firstly comprise straight lines. The lines can also be curved, form wavy lines or be distributed in circular or spiral fashion over the foil.

The depth of the depression is up to a maximum of ⅓ of the thickness of the metal seal (typically approximately 1/10 of the thickness of the metal seal). The foil is, for example, lanceolated and is a maximum of from 16 to 35 μm thick and typically has a width of from 1.2 to 6 mm.

In accordance with a further advantageous embodiment of the invention, the metal seal is provided with perforations. With the perforations there is the advantage that the material of the lamp bulb can pass through the perforations in the region of the pinch seal. The material of the lamp bulb of one side of the pinch seal passes through the perforation and comes into contact with the material of the lamp bulb on the other side of the pinch seal. Glass therefore comes into contact with glass and the two are fused to one another. The metal seal is enclosed very well by the material of the lamp bulb. This results in a tight pinch seal which is simple to produce.

In accordance with one variant of this exemplary embodiment of the invention, the embodiment of the perforations is also different. The perforations can be punctiform, i.e. in the form of holes, in the same way as the depressions, the arrangement of the perforations in turn being implemented as desired or in accordance with a certain pattern. Slit-shaped perforations are likewise provided.

In accordance with a particularly preferred exemplary embodiment, the depressions or the perforations are arranged in such a way that they follow an inscription. The metal seal can be identified by an inscription. This identification can even be seen through the pinch seal. By means of such an inscription, it is not only the metal seal for itself but the lamp per se which is provided with an identification. It is therefore possible to apply, for example, the lamp type, the company logo, the manufacturing date or else other designations or symbols necessary for production to the metal seal.

With the laser processing, in accordance with a further exemplary embodiment of the invention perforations or sharp-edged depressions are introduced at the circumference of the metal seal, which perforations or depressions, in the case of parallel side walls, result in strain-relief fissures in the pinch seal. Strain-relief fissures are provided for the purpose of reducing general stresses in the material. As a result of the different coefficients of thermal expansion of quartz glass (approximately 0.5×10⁻⁶ 1/K) and high-melting refractory metals (approximately 5 to 6×10⁻⁶ 1/K), stresses occur, directly after the pinch-sealing (approximately 2300° C.) during cooling, in the quartz glass/metal composite system. As a result of the strain-relief fissures, the fissures in the glass can be guided in a targeted manner or used for the purpose of reducing local stresses.

The strain-relief fissures in the simplest embodiment comprise slits, which are introduced into the edge of the metal seal or the power supply lines/feed lines. The strain-relief fissures can preferably be in the form of annular fissures, which are arranged distributed over the circumference of the metal seal/power supply lines/feed lines. However, they can also have a different shape.

Molybdenum, for example, is selected as the material for the metal seal. Before it is processed by means of the laser, the foil is joined to the power supply wire and the feed line. The power supply wire consisting of tungsten or molybdenum and the feed line are welded to the foil. Then, preferably the molybdenum foil, but generally also the power supply wires and feed lines embedded in the pinch seal, are processed by the laser.

After the processing, the power supply system is introduced into the still open lamp bulb and the lamp bulb is closed by means of pinch-sealing of the quartz glass, which is preferably at a temperature of approximately 2300° C. The material of the lamp bulb surrounds the metal seal, enters the depressions or the perforations and forms a reliable sealing of the pinch seal, with the result that no gas, in particular an inert gas doped with a halogen additive, which has been introduced in the lamp bulb, can escape. As a result of the depressions or the perforations, the surface of the foil which is joined to the material of the lamp bulb is enlarged.

In accordance with a particular variant of the invention, not only the metal seal but also the power supply wires and the feed line are provided with a structure. The feed line has a surface which is processed by means of a laser at least in the region of the pinch seal in order to improve the join between it and the material of the lamp bulb.

A CO₂ or else an Nd:YAG laser is advantageously used as the laser.

Technically, an Nd:YAG or CO₂ laser with an extremely small focus diameter (<100 μm) and a high laser power at the focus can be used. Usually, the laser is operated during pulsed operation at frequencies of >10 kHz and with a power range of between 10 and 200 watts. The production of the surface structure takes place via the sublimation of the material of the metal seal.

In order to achieve the specific geometries or arrangements of the depressions and/or perforations, a scanner is provided, for example. This scanner is used to introduce any desired shapes and figures onto or into the metal seal and the power supply wires and feed lines. It is also possible to scan relatively large areas by means of the scanner. Scanning in this case means vaporizing the material of the metal seal over a relatively large area so that it has a roughened surface.

As aspect of the invention is directed to discharge lamps.

A halogen incandescent lamp has a lamp bulb consisting of quartz glass. Quartz glass only fuses at substantially higher temperatures than hard glass or soft glass. The embedding of power supply wires into soft glass is relatively simple and does not require means which are as complex, such as the fusing of power supply wires into quartz glass.

### BRIEF DESCRIPTION OF THE DRAWINGS

An exemplary embodiment of the invention will be described below with reference to the following drawings:

FIG. 1 shows a halogen incandescent lamp;

FIG. 2 shows an enlarged detail of the halogen incandescent lamp shown in FIG. 1; and

FIGS. 3-5 show further exemplary embodiments of the foil region for a lamp.

### DETAILED DESCRIPTION OF THE DRAWINGS

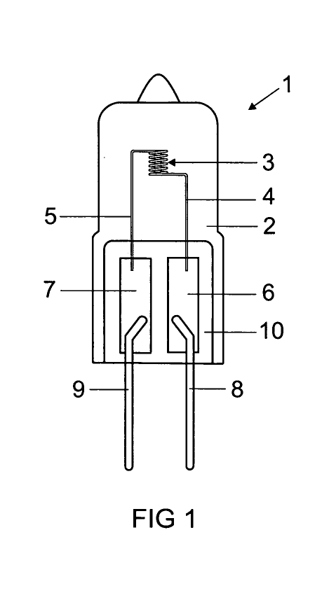

FIG. 1 illustrates a halogen incandescent lamp 1. The lamp bulb 2 consists of quartz glass. The luminous element 3 is arranged in the lamp bulb 2. The ends of the luminous element 3 are connected to the power supply wires 4, 5 of a power supply system.

The power supply system comprises the power supply wires 4, 5, molybdenum foils 6, 7, which are connected to the power supply wires 4, 5, and feed lines 8, 9, which are connected to the molybdenum foils 6, 7. The foils are illustrated schematically, see below.

At the lower end of FIG. 1, the lamp bulb 2 is shown as being closed with a pinch seal 10. The pinch seal 10 surrounds those ends of the power supply wires 4, 5 which are remote from the luminous element 3, the molybdenum foils 6, 7 and those ends of the feed lines 8, 9 which are connected to the molybdenum foils 6, 7. The luminous element 3 is supplied with electrical current via the power supply system.

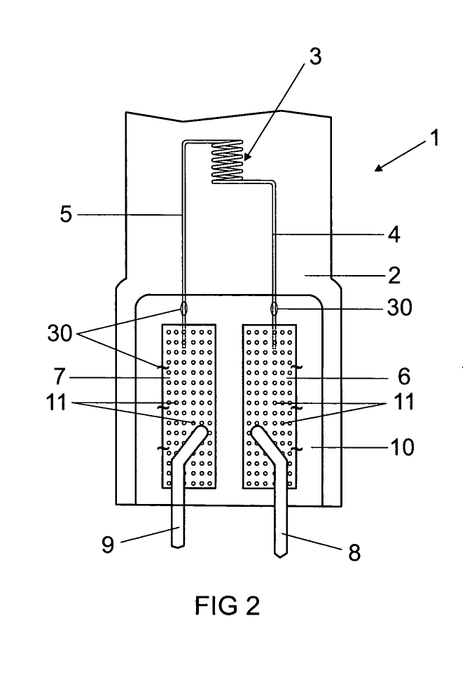

A portion of FIG. 1 is illustrated in FIG. 2 in an expanded view. As can be seen, the molybdenum foils 6, 7 have been provided with perforations 11. These perforations 11 comprise simple holes, which have been introduced into the foil 6, 7 by means of a laser, for example a CO₂ or Nd:YAG laser. The light beam of the laser is focused on the surface of the foil 6, 7. At this point, the material of the foil 6, 7 is hot in such a way that the material is vaporized, in particular sublimated, i.e. the material transfers from a solid state of aggregation immediately into a gaseous state. In this way the perforations are burnt into the foil 6, 7. The arrangement of the perforations is predetermined by means of a scanner. In addition, strain-relief fissures 30 in the foil region are shown schematically. More details on strain-relief fissures can be found, for example, in EP 944 109, the subject matter of which is hereby incorporated by reference.

The drawing depicts perforations in very schematized form as holes. As has been described previously, the perforations can also be in the form of slits. In this case, the slits follow a straight line or a curve. The shape of the perforations is as desired.

In accordance with a further embodiment of the invention, see FIG. 5, depressions 12 in the surface of the foils 6 are also possible as an alternative to perforations 11. These depressions typically enter the material of the foils by up to ⅓ (preferably 1/10). In this case, too, the shape of the depression can be punctiform. In accordance with another embodiment, the depressions are in the form of lines, these lines following a straight line or a curve. The depressions 12 are advantageously provided on both sides of the foil; see FIG. 5. However, it is also possible for the depressions to be applied to only one side of the foils. The patterns of the depressions can be formed identically or differently on each side of the foil. The shape is not subject to any limitations.

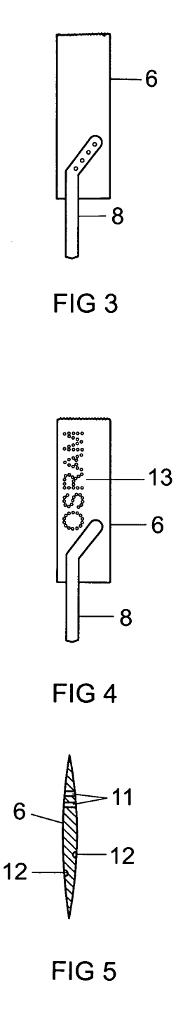

Furthermore, it is possible to apply such depressions in addition or on their own to the feed line 8; see in this regard FIG. 3. lamp as a whole can be identified. The inscription can only be seen relatively weakly through the pinch seal. It therefore does not disrupt the overall appearance of the lamp. The inscription is provided in particular for identification purposes. The structure can be a depression or a perforation.

Forming the foils with an enlarged surface structure results in an electric lamp in which the join between the metal seal and the material of the lamp bulb in the region of the pinch seal is improved. The application or introduction of the depressions or the perforations can be produced in a substantially more simple and quicker manner which is more gentle on the material than in the known methods, such as etching or mechanical processing.

Generally, the metal seal comprises a metal foil, molybdenum, doped or undoped, being preferred as the material, as is known per se. Conventionally, the lamp bulb 2 consists of glass, in particular quartz glass or Vycor.

The structure on the foil can be applied prior to or after fuse-sealing of the foil. Depending on this, a laser with a different wavelength can then be used. In the case of subsequent structuring, it should be selected in such a way that the quartz glass surrounding the foil acts in as non-absorbing fashion as possible, for example, if the wavelength of 1.06 μm (ND:YAG) is used.

The structure on the foil can be used more effectively to improve the glass-sealing or to guide strain-relief fissures depending on the precise shape. The glass-sealing is improved when simply roughening the foil and in the case of smooth structures, for example funnel-like perforations with smooth edges. The strain-relief fissures are guided in optimum fashion when the structure has sharp-edged edges.

If both are desired, either the laser processing can be set in a targeted manner so that structures are produced which are not completely smooth and are not completely sharp-edged or, alternatively, an alternating structure can be applied, with a set of smooth structures and a second set of sharp-edged structures. For example, the first set comprises rows of smooth structures and the second set comprises sharp-edged perforations. The nuclei of cracks existing in the glass are then guided from one structure to another and, as a result, are useful strain-relief means.

We claim:

1. An electric lamp comprising:
a hermetically sealed lamp bulb;
at least one luminous means arranged in the interior of the lamp bulb; and
a power supply system for the luminous means;
wherein said power supply system is passed out of the lamp bulb through a pinch seal, which hermetically seals off the lamp bulb; and
wherein said power supply system includes a laser-processed metal foil seal in the region of the pinch seal.

2. The electric lamp as claimed in claim 1, wherein the metal foil seal comprises a laser-processed structure.

3. The electric lamp as claimed in claim 2, wherein the laser-processed structure is at least one depression in the form of points, straight lines or curves.

4. The electric lamp as claimed in claim 2, wherein the laser-processed structure is embodied as at least one perforation.

5. The electric lamp as claimed in claim 2, wherein the laser-processed structure is an inscription.

6. The electric lamp as claimed in claim 1, wherein the laser-processed structure is adapted to cause local fissures in the glass after fusing, which fissures act as strain-relief fissures.

7. The electric lamp as claimed in claim 3, wherein the depressions produced by means of a laser are incorporated on one side or both sides of the metal foil.

8. The electric lamp as claimed in claim 1, wherein the metal seal comprises a molybdenum foil.

9. The electric lamp as claimed in claim 8, wherein the metal foil has a planar, flat geometry or a laterally folded geometry.

10. The electric lamp as claimed in claim 1, wherein the power supply system comprises a power supply wire, which is connected to the luminous means, the metal foil seal and at least one feed line, which is passed out of the lamp bulb, and the metal seal is arranged between the power supply wire and the feed line.

11. The electric lamp as claimed in claim 10, wherein the end of the power supply wire which is remote from the luminous element or the electrode, the metal seal and that end of the feed line which is connected to the metal seal are embedded in the pinch seal.

12. The electric lamp as claimed in claim 2, wherein the material of the lamp bulb at least partially fills the structure.

13. The electric lamp as claimed in claim 12, wherein the structure is a perforation, and in the region of the pinch seal the glass material passes through the perforation and is connected to the glass material on the other side of the perforation.

14. The electric lamp as claimed in claim 1, wherein the surface of the feed lines and/or of the power supply wires includes a structure in the region of the pinch seal.

15. The electric lamp as claimed in claim 14, wherein the structure of the feed lines and of the power supply wires is produced by a laser.

16. A method for producing a structure on a metal fuse seal, wherein the structure is produced by means of a laser beam.

17. The method as claimed in claim 16, wherein a CO₂ laser or an Nd:YAG laser is used as the laser.

18. The method as claimed in claim 16, wherein the beam of the laser is focussed and the irradiation by means of the laser brings about thermal sublimation of the material of the metal seal.

19. The method as claimed in claim 16, wherein a scanner is provided by means of which the structure is applied in scannable fashion to the metal seal.

20. The method as claimed in claim 16, wherein the untreated beam is split into two beam elements via a beam splitter and the structure is applied to both sides of the metal seal by means of two opposing scanners.

21. The method as claimed in claim 16, wherein the scanned metal fuse seal is rotated during laser treatment.

22. The method as claimed in claim 16, wherein the structure is produced on the fused-in metals (power supply wires, metal foil, feed line) prior to the fusing with the quartz glass.

23. The method as claimed in claim 16, wherein the structure is produced on the fused-in metals (power supply wires, metal foil, feed line) after the fusing with the quartz glass, the wavelength of the laser being selected in such a way that the laser beam can pass through the quartz glass without any noticeable attenuation, in particular is selected to be at least 1.06 μm.
